(19) United States
(12) Patent Application Publication
(10) Pub. No.: US 2002/0193515 A1
(43) Pub. Date: Dec. 19, 2002

(54) Polarization film containing a monoazo compound or salt

(76) Inventors: Yoshiteru Ohta, Ikoma-gun (JP); Toru Ashida, Osaka (JP); Narutoshi Hayashi, Niihama-shi (JP)

Correspondence Address: STEVENS, DAVIS, MILLER & MOSHER, L.L.P., Suite 850, 1615 L Street, N.W., Washington, DC, 20036, US

(21) Appl. No.: 10/103,765

(22) Filed: Mar. 25, 2002

(30) Foreign Application Priority Data
Mar. 28, 2001 (JP) 2001-092327

(51) Int. Cl. C08L 61/00

(52) U.S. Cl. 525/30

(57) ABSTRACT

There is provided a polarization film for near ultra-violet polarization plate manifesting high polarization ability at the near ultra-violet range of 370-400 nm, having sufficient endurance, and containing a monoazo compound represented by the following formula (I) or a salt thereof:

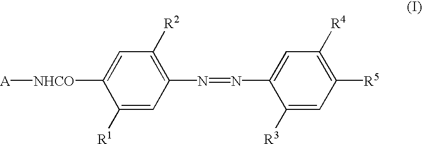

wherein

A represents a naphthyl having 1 to 3 sulfos or a phenyl having 1 to 2 water-soluble groups selected from sulfo and carboxyl and optionally having a lower alkyl or lower alkoxy,

R¹ to R⁴ are the same or different and represent hydrogen, lower alkyl or lower alkoxy, and

R⁵ represents —OR⁶ or —NHR⁶ wherein R⁶ represents hydrogen, lower alkyl, lower alkyl sulfonyl, benzene sulfonyl, toluene sulfonyl, lower alkyl carbonyl or benzoyl, wherein the benzoyl is unsubstituted or substituted with nitro, amino or sulfo.

### BACKGROUND OF THE INVENTION

The present invention relates to a polarization film for near ultra-violet polarization plate containing a monoazo compound or a salt thereof.

Ultra-violet polarization plates, which change a ultra-violet ray to a liner polarized light, have been used in a spectroscopic analysis device such as fluorescent spectrophotometer, a light exposure device for irradiating ultra-violet ray, and the like. Further, near ultra-violet polarization plate is used in a liquid crystal display device having a back-light emitting a near ultra-violet ray and a fluorescent substance layer emitting a light due to the near ultra-violet ray. This type of liquid crystal display device is often named photo-luminescence liquid crystal display device. As a polarization film constituting a ultra-violet polarization plate or a near ultra-violet polarization plate, an iodine-based polarization film incorporating iodine into a substrate such as an oriented polyvinyl alcohol film or the like has been known.

Iodine-based polarization films manifest a problem of decrease in abilities thereof under high temperature and high humidity conditions, since they have poor endurance to heat and poor endurance to water. Some methods are studied for enhancing such endurances, such as a method in which treatment is effected with an aqueous solution containing formaldehyde or boric acid, a method in which a polymer film having low water vapor permeability is used as a protective film, and the like. However, iodine-based polarization films having sufficient endurance have not been obtained yet.

The present inventors have conducted extensive studies for solving the above problems. As the result, they have found that a polarization film containing a specific monoazo compound or a salt thereof exhibits high polarization ability at the near ultra-violet range of 370-400 nm and has sufficient endurance even under conditions of high temperature and high humidity. Thus, the present invention was completed based on the findings.

### SUMMARY OF THE INVENTION

Namely, the present invention provides a polarization film for near ultra-violet polarization plate containing a monoazo compound represented by the following formula (I) or a salt thereof:

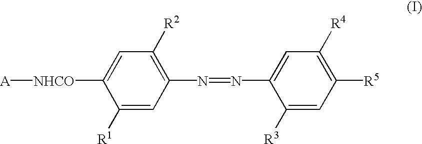

wherein

A represents a naphthyl having 1 to 3 sulfos or a phenyl having 1 to 2 water-soluble groups selected from sulfo and carboxyl and optionally having a lower alkyl or lower alkoxy,

R¹ to R⁴ are the same or different and represent hydrogen, lower alkyl or lower alkoxy, and

R⁵ represents —OR⁶ or —NHR⁶ wherein R⁶ represents hydrogen, lower alkyl, lower alkyl sulfonyl, benzene sulfonyl, toluene sulfonyl, lower alkyl carbonyl or benzoyl, wherein the benzoyl is unsubstituted or substituted with nitro, amino or sulfo.

The present invention further provides a monoazo compound represented by the following formula (I′) or a salt thereof:

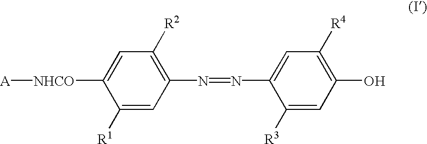

wherein R¹ to R⁴ and A are as defined above. The monoazo compound represented by the formula (I′) is a specific compound included in the monoazo compound represented by the above formula (I).

### BRIEF EXPLANATION OF THE DRAWING

FIG. 1 is a schematic cross sectional view of a photo-luminescence liquid crystal display device.

### Explanation of Reference Numerals

10: back light

20: liquid crystal cell

30: liquid crystal panel

31, 31: polarization plate

40: fluorescent substance layer

41: red fluorescent substance

42: green fluorescent substance

43: blue fluorescent substance

### DETAILED DESCRIPTION OF PREFERRED EMBODIMENTS

“A” in the above-mentioned formula (I) represents a naphthyl having 1 to 3 sulfos or a phenyl having 1 to 2 water-soluble groups selected from sulfo and carboxyl and optionally having a lower alkyl or lower alkoxy. The lower alkyl or lower alkoxy is preferably a linear or branched group having 1 to 4 carbon atoms. Specific examples of the lower alkyl include methyl, ethyl, propyl and the like. Specific examples of the lower alkoxy include methoxy, ethoxy, propoxy and the like.

As the phenyl represented by A, an unsubstituted phenyl having 1 to 2 water-soluble groups selected from sulfo and carboxyl is preferable. Examples of the phenyl represented by A include 2-, 3- or 4-sulfophenyl, 2-, 3- or 4-carboxyphenyl, 2,4- or 2,5-disulfophenyl, 3,5-dicarboxyphenyl, 2-carboxy-4- or -5-sulfophenyl, 2- or 3-methyl-4-sulfophenyl, and the like. Among them, 4-sulfophenyl is more preferable.

As the naphtyl represented by A, 2-naphthyl having 1 to 3 sulfos is preferable. Examples of the naphthyl represented by A include 5-, 6-, 7- or 8-sulfo-2-naphthyl, 4-, 5-, 6- or 7-sulfo-1-naphthyl, 1,5-, 6,8-, 4,8-, 5,7- or 3,6-disulfo-2-naphthyl, 3,6- or 4,6-disulfo-1-naphthyl, and 1,5,7-, 3,6,8- or 4,6,8-trisulfo-2-naphthyl and the like. Among them, naphthyls having 2 sulfo groups are more preferable, and disulfo-2-naphthyls are particularly preferable.

R¹ to R⁴, which are the same as or different from each other, represent hydrogen, lower alkyl or lower alkoxy. As the lower alkyl and lower alkoxy, linear or branched groups having 1 to 4 carbon atoms are preferable. As specific examples of the lower alkyl, methyl, ethyl, propyl and the like are listed. As specific examples of the lower alkoxy, methoxy, ethoxy, propoxy and the like are listed. R′ to R⁴ preferably represent hydrogen or methyl.

R⁵ in the formula (I) preferably represents —OR⁶.

R⁶ represents hydrogen, lower alkyl, lower alkyl sulfonyl, benzene sulfonyl, toluene sulfonyl, lower alkyl carbonyl or benzoyl. The benzoyl may be either unsubstituted or substituted with nitro, amino or sulfo.

The lower alkyl represented by R⁶ may be a linear or branched group having 1 to 4 carbon atoms and specific examples thereof include methyl, ethyl, propyl and the like.

Examples of the lower alkyl sulfonyl represented by R⁶ include methylsulfonyl, ethylsulfonyl and isopropylsulfonyl.

Examples of the lower alkyl carbonyl represented by R⁶ include acetyl, propionyl, butyryl, isobutyryl and pivaloyl.

Examples of the benzoyl include benzoyl, p-aminobenzoyl, p-nitrobenzoyl and p-sulfobenzoyl.

The monoazo compound represented by the formula (I′) or a salt thereof can be produced, for example, by the following method.

First, a compound of the following formula (II):

A—NH₂ (II)

wherein A is as defined above, is reacted with a compound of the following formula (III):

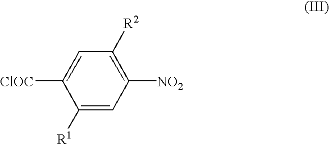

wherein R¹and R² are as defined above, in a neutral aqueous medium under conditions of 30 to 100° C. The resulted compound is reduced with iron powder, and the amide compound thus obtained is diazotized by reacting with sodium nitrite in an acidic aqueous medium under a condition of 5 to 40° C. The resulted diazotized compound is reacted with a compound of the following formula (IV):

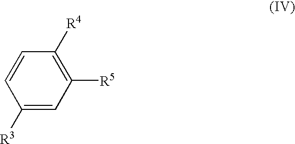

wherein, R³ R⁴ and R⁵ are as defined above, in an aqueous medium under conditions of 5 to 40° C. and pH from 6 to 11, to obtain a monoazo compound of the formula (I) or a salt thereof.

Examples of the monoazo compound of the formula (I) include the following compounds:

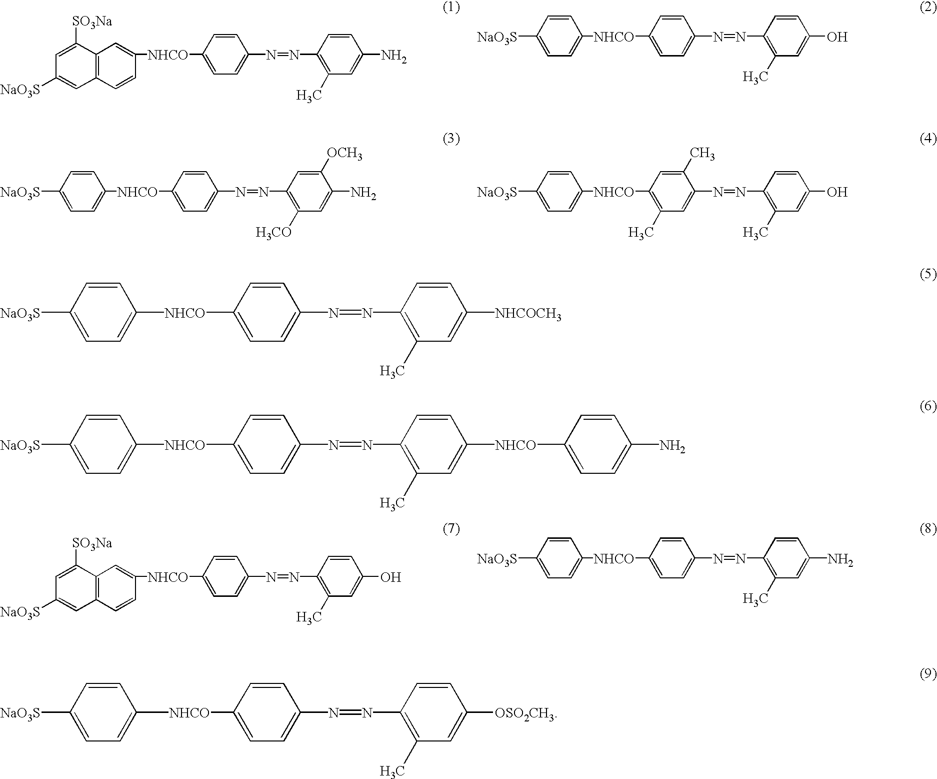

As examples of the salt of a monoazo compound (I), alkali metal salts such as a lithium salt, sodium salt and potassium salt, an ammonium salt, and organic amine salts such as an ethanolamine salt and alkylamine salt, and the like are listed. When the monoazo compound of the formula (I) is added into a polarization film substrate, a compound in the form of a sodium salt is preferably used.

The polarization film for near ultra-violet polarization plate of the present invention can be produced by adding a dichromatic dye comprising a monoazo compound of the formula (I) or a salt thereof or a dichromatic dye further comprising other organic dye, into a polymer film, polarization film substrate, by a known method. Examples of this polymer film include polymer films made of polyvinyl alcohol-based resins, polyvinyl acetate resins, ethylene/vinyl acetate (EVA) resins, nylon resin, polyester resins or the like. Examples of the polyvinyl alcohol-based resin herein referred to include a partial or complete saponified polyvinyl acetate, that is polyvinyl alcohol; saponified substances of copolymers of vinyl acetate with other copolymerizable monomers, for example, olefins such as ethylene and propylene, unsaturated carboxylic acids such as crotonic acid, acrylic acid, methacrylic acid and maleic acid, unsaturated sulfonic acids, vinyl ethers, and the like, such as saponified EVA resins; polyvinyl formal and polyvinyl acetal obtained by denaturing polyvinyl alcohol with an aldehyde, and the like. As the polarization film substrate, polyvinyl alcohol-based films, particularly, a polyvinyl alcohol film is suitably used from the standpoints of adsorbing property and orientation property of a dye.

For adding a dichromatic dye into such a polymer film, a method of dyeing a polymer film is usually adopted. Dyeing can be effected, for example, according to the following method. First, a dichromatic dye is dissolved in water to prepare a dye bath. The concentration of a dye in the dye bath is not particularly restricted, but usually selected in the range from 0.0001 to 10% by weight. If necessary, a dyeing aid may be used. For example, sodium sulfate may be used as the dyeing aid and its amount is preferably from 0.1 to 10% by weight in a dye bath. A polymer film is immersed into the dye bath thus prepared, and dyeing is effected. The dyeing temperature is preferably from 40 to 80° C. Orientation of a dichromatic dye is conducted by drawing a polymer film. As the drawing method, any known method such as a wet method, dry method and the like may be adopted, for example. Drawing of a polymer film may be conducted before dyeing or after dyeing.

A polymer film obtained by adding and orientating a dichromatic dye is subjected, if necessary, to a post treatment such as boric acid treatment and the like according to a known method. Such a post treatment is effected for improving light transmittance, degree of polarization and endurance of a polarization film. Though conditions of the boric acid treatment differ depending on the kind of a polymer film used and the kind of a dye used, the boric acid treatment is generally effected using a boric acid aqueous solution having a concentration of from 1 to 15% by weight, preferably from 5 to 10% by weight at a temperature ranging from 30 to 80° C., preferably from 50 to 80° C. Further, if necessary, a fix treatment may be together conducted using an aqueous solution containing a cationic polymer compound.

A protective film excellent in optical transparency and mechanical strength can be pasted on one surface or both surfaces of thus obtained polarization film, to give a polarization plate. The material forming a protective film may be which conventionally used. For example, films composed of a fluorine resin such as an ethylene tetrafluoride/propylene hexafluoride copolymer, polyester-based films, polyolefin-based films, polyamide-based films and the like may be used, in addition to cellulose acetate-based films and acrylic films.

The following examples illustrate the present invention further in detail, but should not be construed to restrict the scope of the invention at all. “%” and “parts” in the examples are by weight unless otherwise stated.

### EXAMPLE 1

67 parts of sulfanilic acid was added to 310 parts of water, and pH was adjusted to 7 with a 28% sodium hydroxide solution. This solution was heated to 80° C., and 79 parts of 4-nitrobenzoyl chloride was added gradually. During this operation, pH was maintained at 7 with a 28% sodium hydroxide solution. Then, the mixture was kept at the same temperature for 1 hour to obtain a nitro compound. A nitro group of this nitro compound was reduced to an amino group with an iron powder, to obtain a corresponding amide compound.

135 parts of the amide compound thus obtained and 25 parts of sodium nitrite were added to 660 parts of water. To this was added 100 parts of 35% hydrochloric acid at room temperature, and the mixture was stirred for 2 hours to convert the amino group to a diazonium salt, giving a reaction solution of a diazo compound.

Separately, 35 parts of m-cresol and 107 parts of sodium bicarbonate were added to 940 parts of water and the mixture was stirred at room temperature. Into the resulted mixed solution was charged over 1 hour the reaction solution of the diazo compound obtained above, and the mixture was further stirred for 1 hour to effect a coupling reaction. A salt of monoazo compound of the above formula (2) was obtained. The salt of the monoazo compound manifested a λmax of 370 nm in an aqueous medium.

### EXAMPLE 2

A salt of monoazo compound of the above formula (7) was obtained according to the same manner as in Example 1 except that monopotassium 7-aminonaphthalene-1,3-disulfonate was used instead of sulfanilic acid. This salt manifested a λmax of 369 nm in an aqueous medium.

### EXAMPLE 3

27 Parts of monoazo compound of the formula (2) was added to a mixed solution of 240 parts of water and 27 parts of N-methyl-2-pyrrolidinone, and the resulted mixture was stirred at room temperature. Maintaining the pH at 9 with an aqueous sodium hydroxide solution, 30 parts of methane sulfonyl chloride was added thereto over 2 hours. After completion of the addition, the mixture was stirred further for one hour to obtain a salt of monoazo compound of the above formula(9). This salt manifested a λmax of 337 nm in an aqueous medium.

### SYNTHESIS EXAMPLE 1

A salt of monoazo compound of the above formula (1) was obtained according to the same manner as in Example 1 except that monopotassium 7-aminonaphthalene-1,3-disulfonate was used instead of sulfanilic acid and m-toluidine was used instead of m-cresol. This salt manifested a λmax of 406 nm in an aqueous medium.

### SYNTHESIS EXAMPLE 2

A salt of monoazo compound of the above formula (8) was obtained according to the same manner as in Example 1 except that m-toluidine was used instead of m-cresol. This salt manifested a λmax of 422 nm in an aqueous medium.

### EXAMPLE 4

A polyvinyl alcohol film [Kuraray Vinylon #7500, manufactured by Kuraray Co., Ltd.] having a thickness of 75 μm was drawn along a longitudinal axis at a magnification ratio of 5, to give a polarization film substrate. This polyvinyl alcohol film was kept under strained condition and immersed in an aqueous solution (dye bath) containing a salt of monoazo compound of the formula (2) in a concentration of 0.025% and sodium sulfate, a dyeing aid in a concentration of 0.2%, at 70° C. Then, the film was immersed in a 7.5% boric acid aqueous solution at 78° C. for 5 minutes. The resulted film was removed from the solution and washed with water at 20° C. for 20 seconds, followed by drying at 50° C. to obtain a polarization film. This polarization film had a λmax (wavelength at which transmittance along drawing direction of a film is minimum.) of 390 nm, had high degree of polarization, and manifested durability over a long time even under conditions of high temperature and high humidity

### EXAMPLE 5

A polarization film was obtained according to the same manner as in EXAMPLE 4 except that the temperature of a dye bath was changed to 65° C. and the temperature of boric acid treatment was changed to 73° C. The resulted polarization film had a λmax of 390 nm. This polarization film had high degree of polarization, and manifested durability over a long time even under conditions of high temperature and high humidity.

### EXAMPLE 6

A polarization film was obtained according to the same manner as in EXAMPLE 4 except that the salt of monoazo compound was changed to a salt of monoazo compound described in the following Table 1. The resulted polarization film had a λmax as described in Table 1. This polarization film had high degree of polarization, and manifested durability over a long time even under conditions of high temperature and high humidity.

TABLE 1

| Salt of monoazo compound | λmax |
|---|---|
| Salt of compound of the formula (1) | 440 nm |
| Salt of compound of the formula (7) | 400 nm |
| Salt of compound of the formula (8) | 450 nm |

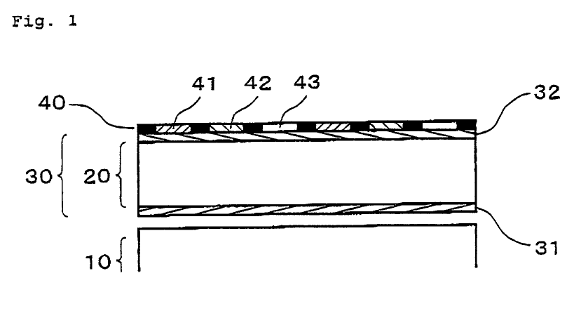

FIG. 1 shows an example of construction of a photo-luminescence liquid crystal display device. This device comprises a back-light (10) emitting a near ultra-violet ray, a liquid crystal panel (30) and a fluorescent substance layer (40) emitting a visible light by being irradiated with the near ultra-violet ray. The liquid crystal panel (30) consists of a liquid crystal cell (20) and two near ultra-violet polarization plates (31), (32) arranged at each of two surfaces of the liquid crystal cell (20). The fluorescent substance layer (40) has fluorescent substances (41), (42), (43), each of which emitting red, green or blue light, respectively, by being irradiated with the near ultra-violetray. Transmission of the near ultra-violet ray from the back light (10) is controlled by electric field control in the liquid crystal cell (20) and the action of the near ultra-violet polarization plates (31), (32). Color display is performed by the emission of one or more of the fluorescent substances (41), (42), (43) caused by the near ultra-violet ray having passed through the liquid crystal panel (30).

The polarization film for near ultra-violet polarization plate of the present invention or manifests high polarization ability at the near ultra-violet range of 370-400 nm and has sufficient endurance even under conditions of high temperature and high humidity. Therefore, the polarization film of the present invention is suitably used for various devices such as a near ultra-violet polarization plate in a liquid crystal display device and the like.

What is claimed is:

1. A polarization film for near ultra-violet polarization plate containing a monoazo compound represented by the following formula (I) or a salt thereof: 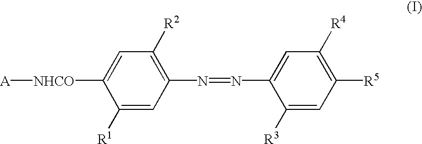
wherein
A represents a naphthyl having 1 to 3 sulfos or a phenyl having 1 to 2 water-soluble groups selected from sulfo and carboxyl and optionally having a lower alkyl or lower alkoxy,
R¹ to R⁴ are the same or different and represent hydrogen, lower alkyl or lower alkoxy, and
R⁵ represents —OR⁵ or —NHR⁶ wherein R⁶ represents hydrogen, lower alkyl, lower alkyl sulfonyl, benzene sulfonyl, toluene sulfonyl, lower alkyl carbonyl or benzoyl, wherein the benzoyl is unsubstituted or substituted with nitro, amino or sulfo.

2. The polarization film according to claim 1, wherein A in the formula (I) represents an unsubstituted phenyl having 1 to 2 water-soluble groups selected from sulfo and carboxyl and a 2-naphthyl having 1 to 3 sulfos.

3. The polarization film according to claim 1, wherein R¹ to R⁴ in the formula (I) each independently represent hydrogen or methyl.

4. The polarization film according to claim 1, wherein R⁵ in the formula (I) represents —OR⁶ wherein R⁶ represents hydrogen, lower alkyl, lower alkyl sulfonyl, benzene sulfonyl, toluene sulfonyl, lower alkyl carbonyl or benzoyl, wherein the benzoyl is unsubstituted or substituted with nitro, amino or sulfo.

5. The polarization film according to claim 1, wherein the polarization film substrate comprises a polyvinyl alcohol film.

6. A monoazo compound represented by the following formula (I′) or a salt thereof: 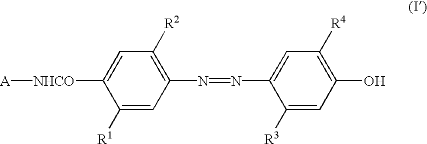
wherein
A represents a naphthyl having 1 to 3 sulfos or a phenyl having 1 to 2 water-soluble groups selected from sulfo and carboxyl and optionally having a lower alkyl or lower alkoxy, and R¹ to R⁴ are the same or different and represent hydrogen, lower alkyl or lower alkoxy.
